(19) United States
(12) Patent Application Publication
(10) Pub. No.: US 2025/0068027 A1
(43) Pub. Date: Feb. 27, 2025

(54) RESONATOR-BASED ACTIVE PHOTONICS WITH REDUCED FOOTPRINT

(71) Applicant: Quantinuum LLC, Broomfield, CO (US)

(72) Inventor: Adam Jay OLLANIK, Boulder, CO (US)

(21) Appl. No.: 18/779,760

(22) Filed: Jul. 22, 2024

Related U.S. Application Data
(60) Provisional application No. 63/578,232, filed on Aug. 23, 2023.

(51) Int. Cl. G02F 1/225; G02F 1/21

(52) U.S. Cl. CPC G02F 1/225; G02F 1/212; G02F 2201/063; G02F 2202/32; G02F 2203/15

(57) ABSTRACT

A resonant photonic element includes a propagation waveguide defining a propagation direction; and a guided mode resonator comprising a periodically perturbed waveguide. The periodically perturbed waveguide is a waveguide that extends a first length in a resonator direction, the resonator direction is transverse to the propagation direction, and the periodically perturbed waveguide intersects the waveguide.

### CROSS-REFERENCE TO RELATED APPLICATIONS

This application claims priority to U.S. Application No. 63/578,232, filed Aug. 23, 2023, the content of which is incorporated herein in its entirety.

### TECHNICAL FIELD

Various embodiments relate to apparatuses, systems, and methods relating resonator-based active micro-photonics. For example, various embodiments relate to apparatuses, systems, and methods relating to resonator-based active photonics and use thereof for interaction with confined particles and/or objects. An example embodiment relates to the use of resonator-based active photonics for interacting with qubits of a quantum computer.

### BACKGROUND

Various active photonic devices and elements use resonators to provide an active photonic and/or light conditioning. These resonators conventionally take the form of high-quality ring resonators having diameters on the range of 100s of microns to a few millimeters. These ring resonators have a significant footprint such that it is difficult to fit a number of optical paths in a small area. These ring resonators also exhibit significant power loss, resulting in a large power requirement for optical systems including the ring resonators. Through applied effort, ingenuity, and innovation many deficiencies of prior systems have been solved by developing solutions that are structured in accordance with the embodiments of the present invention, many examples of which are described in detail herein.

### BRIEF SUMMARY OF EXAMPLE EMBODIMENTS

Example embodiments provide resonant photonic elements, optical components including such resonant photonic elements, systems including such resonant photonic elements, and/or the like. In various embodiments, the resonant photonic elements or optical components comprising the resonant photonic elements are part of beam path systems for providing optical beams for interacting with particles and/or causing particle interactions.

In various embodiments, a resonant photonic element includes a guided mode resonance (GMR) quasi-bound state in the continuum (Q-BIC) resonator. In various embodiments, the resonant photonic element includes a propagation waveguide configured for guiding a guided mode. For example, the propagation waveguide is configured for propagating and/or guiding an optical beam along a length thereof. The propagation waveguide defines a propagation direction. In various embodiments, the resonant photonic element includes a guided mode resonator that includes a periodically perturbed waveguide. The periodically perturbed waveguide is a waveguide that extends a length in a resonator direction. The resonator direction is transverse to the propagation direction such that the periodically perturbed waveguide and the propagation waveguide intersect.

The periodically perturbed waveguide has a periodic perturbation formed therein. For example, in an example embodiment, the periodic perturbation takes the form of a periodic series of notches in one or more surfaces of the periodically perturbed waveguide. The resonator direction is transverse to the propagation direction.

According to an aspect of the present disclosure, a resonant photonic element is provided. The resonant photonic element includes a propagation waveguide defining a propagation direction; and a guided mode resonator comprising a periodically perturbed waveguide. The periodically perturbed waveguide is a waveguide that extends a first length in a resonator direction, the resonator direction is transverse to the propagation direction, and the periodically perturbed waveguide intersects the waveguide.

In an example embodiment, the periodically perturbed waveguide has a first surface and a second surface, the first surface of the periodically perturbed waveguide being opposite the second surface of the periodically perturbed waveguide with respect to the propagation direction, and the periodically perturbed waveguide is a waveguide comprising at least one of notches in at least one of the first surface of the periodically perturbed waveguide or the second surface of the periodically perturbed waveguide, holes along a center of the periodically perturbed waveguide, bumps along at least one of the first surface or the second surface, or a periodic structure in a refractive index or absorption of the periodically perturbed waveguide. Various other perturbations may be used in various other embodiments as appropriate for the application.

In an example embodiment, the guided mode resonator is formed of material that has an index of refraction that can be actively modified/controlled.

In an example embodiment, the resonant photonic element further includes a modification material disposed in proximity to the guided mode resonator, wherein the modification material is actively modifiable, and modification of the modification material causes a change in a resonance of the guided mode resonator.

In an example embodiment, the guided mode resonator and at least a portion of the propagation waveguide are at least partially embedded in an active material.

In an example embodiment, the guided mode resonator is formed of active material and the resonant photonic element is a laser or optical amplifier.

In an example embodiment, the guided mode resonator is formed of a non-linear material and the resonant photonic element is configured to perform down-conversion or up-conversion.

In an example embodiment, the resonant photonic element is an amplitude modulator or a switch.

In an example embodiment, the resonant photonic element is a frequency filter.

In an example embodiment, the periodically perturbed waveguide comprises a first periodically perturbed waveguide arm and a second periodically perturbed waveguide arm, the first periodically perturbed waveguide arm and the second periodically perturbed waveguide arm overlap where the first periodically perturbed waveguide arm and the second periodically perturbed waveguide arm intersect the propagation waveguide, and the first periodically perturbed waveguide arm and the second perturbed waveguide arm are transverse to one another.

In an example embodiment, the resonant photonic element is a phase modulator.

In an example embodiment, the phase modulator is part of a Mach-Zehnder interferometer.

In an example embodiment, the periodically perturbed waveguide is symmetric with respect to an axis that is transverse or perpendicular to the propagation direction.

In an example embodiment, the periodically perturbed waveguide comprises a first surface and a second surface, the first surface being opposite the second surface with respect to the propagation direct, and a periodic perturbation of the periodically perturbed waveguide is present on only one of the first surface or the second surface.

In an example embodiment, the resonant photonic element is an optical isolator.

In an example embodiment, the propagation waveguide is a Huygens waveguide or a sub-wavelength grating waveguide.

In an example embodiment, the periodically perturbed waveguide is a Huygens waveguide or a sub-wavelength grating waveguide.

In an example embodiment, a perturbation of the periodically perturbed waveguide is a non-symmetry with respect to the direction of propagation in the Huygens waveguide or the sub-wavelength grating waveguide.

According to another aspect, a system is provided. The system includes a confinement apparatus configured to confinement apparatus configured to confine manipulatable objects and defining, at least in part, at least one target location; a manipulation source configured to generate and provide a manipulation signal; and a beam path system, the beam path system configured to guide a manipulation signal generated by the manipulation source to the at least one target location, the beam path system comprising an resonant photonic element. The resonant photonic element includes a propagation waveguide defining a propagation direction; and a guided mode resonator comprising a periodically perturbed waveguide. The periodically perturbed waveguide is a waveguide that extends a first length in a resonator direction, the resonator direction is transverse to the propagation direction, and the periodically perturbed waveguide intersects the waveguide.

In an example embodiment, the periodically perturbed waveguide has a first surface and a second surface, the first surface of the periodically perturbed waveguide being opposite the second surface of the periodically perturbed waveguide with respect to the propagation direction, and the periodically perturbed waveguide is a waveguide comprising at least one of notches in at least one of the first surface of the periodically perturbed waveguide or the second surface of the periodically perturbed waveguide, holes along a center of the periodically perturbed waveguide, bumps along at least one of the first surface or the second surface, or a periodic structure in a refractive index or absorption of the periodically perturbed waveguide.

In an example embodiment, the resonant photonic element is at least one of a modulator or a frequency filter.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example resonant photonic element, according to an example embodiment.

FIG. 2 is a schematic diagram illustrating another example resonant photonic element, according to an example embodiment.

FIGS. 3A and 3B are schematic diagrams that each illustrate an example resonant photonic element comprising a respective Huygens waveguide having a respective perturbation, according to an example embodiment.

FIGS. 4A and 4B are schematic diagrams that each illustrate an example resonant photonic element comprising a respective Huygens waveguide having a periodic perturbation, according to an example embodiment.

FIG. 5 provides a cross-section of an example resonant photonic element comprising a modification material configured for actively and/or dynamically modifying the resonant wavelength of the guided mode resonator of the resonant photonic element, according to an example embodiment.

FIG. 6 provides a cross-section of an example resonant photonic element where the propagation waveguide and the periodically perturbed waveguide are at least partially embedded in an active or non-linear material, according to an example embodiment.

FIG. 7 provide a cross-section of an example resonant photonic element where an acoustic or pressure wave is used to actively and/or dynamically modify the resonant wavelength of the guided more resonator of the resonant photonic element, according to an example embodiment.

FIG. 8 provides a cross-section of an example asymmetric resonant photonic element, according to an example embodiment.

FIG. 9 is a schematic diagram of an example embodiment system including resonant photonic elements, according to an example embodiment.

FIG. 10 provides a schematic diagram of an example controller of a system including resonant photonic elements, according to an example embodiment.

FIG. 11 provides a schematic diagram of an example computing entity of a system including resonant photonic elements, according to an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Various embodiments provide resonant photonic elements, optical components including resonant photonic elements, systems including resonant photonic elements, and/or the like. In various embodiments, the resonant photonic elements or optical components comprising the resonant photonic elements are part of beam path systems for providing optical beams for interacting with particles and/or causing particle interactions.

As used herein a resonant photonic element is a photonic element with a frequency-dependent photonic response. In various embodiments, a resonant photonic element is an active photonic element. An active photonic element is a photonic element where the operation of the photonic element is controlled at least in part based on an externally provided control signal (e.g., an electrical or optical signal). In various embodiments, a resonant photonic element is a passive photonic element. A passive photonic element is not configured to receive an external control signal.

In various embodiments, a resonant photonic element includes a guided mode resonance (GMR) quasi-bound state in the continuum (Q-BIC) resonator. In various embodiments, the resonant photonic element includes a propagation waveguide configured for guiding a guided mode. For example, the propagation waveguide is configured for propagating and/or guiding an optical beam along a length thereof. The propagation waveguide defines a propagation direction. In various embodiments, the resonant photonic element includes a guided mode resonator that includes a periodically perturbed waveguide. The periodically perturbed waveguide is a waveguide that extends a length in a resonator direction. The resonator direction is transverse to the propagation direction such that the periodically perturbed waveguide and the propagation waveguide intersect.

The periodically perturbed waveguide has a periodic perturbation formed therein. For example, in an example embodiment, the periodic perturbation takes the form of a periodic series of notches in one or more surfaces of the periodically perturbed waveguide. The resonator direction is transverse to the propagation direction.

Conventionally, high quality resonators used to perform active photonic functions are formed by ring resonators having diameters on the order of several hundred microns to a millimeter. These ring resonators take up a significant amount of physical space and result in a significant amount of power dissipation. For optical channels that include several to many optical channels or for systems having stringent space and/or power requirements, the large conventional ring resonators cause significant technical challenges.

Various embodiments provide technical solutions to these technical problems. For example, various embodiments provide resonant photonic elements including high quality (high-Q) GMR Q-BIC resonators. These high-Q GMR Q-BIC resonators are significantly smaller than conventional high-Q ring resonators (e.g., having lengths of less than 100 microns compared to diameters of the ring resonators of several hundred microns to a millimeter) and dissipate significantly less power. Thus, various embodiments provide technical improvements to the fields of resonant photonic elements, optical components comprising resonant photonic elements, and systems comprising optical components.

### Example Resonant Photonic Elements

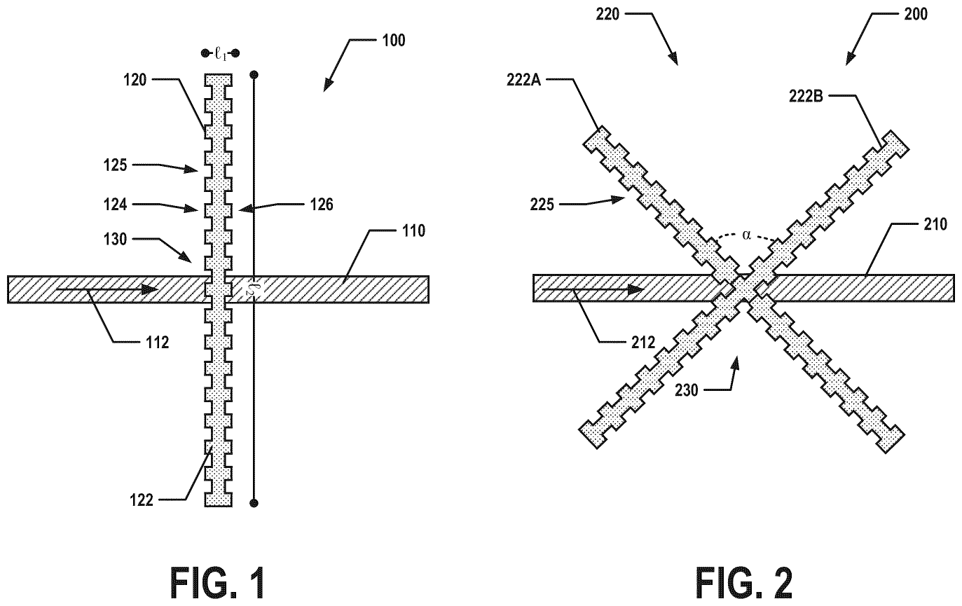

FIG. 1 illustrates an example resonant photonic element 100, according to an example embodiment. The resonant photonic element 100 includes a propagation waveguide 110. The propagation waveguide 110 is configured to propagate and/or guide light along the propagation waveguide 110. The propagation waveguide 110 defines propagation direction 112. The propagation direction 112 is the direction along which the propagation waveguide 110 is configured to propagate and/or guide light along the propagation waveguide 110.

The resonant photonic element 100 further includes a guided mode resonator 120. The guided mode resonator 120 includes a periodically perturbed waveguide 122. The periodically perturbed waveguide 122 is a waveguide that includes periodic perturbations 125. In the illustrated embodiment, the periodic perturbations 125 are periodic notches in the first surface 124 and the second surface 126 of the periodically perturbed waveguide 122. In various embodiments, the periodic perturbations 125 are holes along the center of the periodically perturbed waveguide 122, bumps (e.g., protrusions and/or protuberances) on the first and/or second surfaces 124, 126, periodic structure in the refractive index or absorption of the material (e.g., alternating materials along the length of the periodically perturbed waveguide 122), and/or other periodic perturbations. In the illustrated embodiments, the first surface 124 and the second surface 126 of the periodically perturbed waveguide 122 are opposite one another with respect to the propagation direction 112.

In various embodiments, the periodically perturbed waveguide 122 extends a length in a resonator direction. In an example embodiment, the resonator direction is transverse to the propagation direction 112. In the illustrated embodiment, the resonator direction is perpendicular to the propagation direction 112. In various embodiments, the periodically perturbed waveguide 122 is transverse to the propagation waveguide 110 such that the periodically perturbed waveguide 11 intersects the propagation waveguide 110 at intersection 130.

In various embodiments, the resonant photonic element 100 is used to control and/or affect the propagation of light along the propagation waveguide 110. For example, light propagates along the propagation waveguide 110 in the propagation direction 112. When the light reaches the intersection 130 where the propagation waveguide 110 and the periodically perturbed waveguide 122 intersect, the light interacts with the periodically perturbed waveguide 122. Light that is not resonant with the guided mode resonator 120 interacts with the guided mode resonator but fails to resonant therewith. The not resonant light therefore passes through the intersection 130 and continues to propagate along the propagation waveguide 110. In various embodiments, light is resonant with the guided mode resonator 120 when the light is characterized by a wavelength (or frequency) and/or polarization that is resonant with the guided mode resonator 120. In various embodiments, light is not resonant with the guided mode resonator 120 when the light is characterized by a wavelength (or frequency) and/or polarization that is not resonant with the guided mode resonator 120. Light that is resonant with the guided mode resonator 120 interacts with the guided mode resonator 120 resonates therewith such that the resonant light is reflected and/or such that the forward propagating resonant light is dampened. In other words, light that is resonant with the guided mode resonator 120 is not propagated along the propagation waveguide 110 past and/or through the intersection 130. In an example embodiment, light that is resonant with the guided mode resonator 120 is backward propagated along the propagation waveguide 110. The backward propagating resonant light may be coupled out of the propagation waveguide 110 and directed to desired location. In various embodiments, the transmittance and/or reflectance of the intersection 130 is a continuous function (e.g., not a step function) of wavelength (or frequency) and/or polarization of the incident light with a well-defined peak at the resonant wavelength (or frequency) and/or polarization.

The periodically perturbed waveguide 122 has a width [symbol] ₁ that is less than five microns. The width [symbol] ₁ is in a direction transverse and/or perpendicular to the resonator direction. For example, in various embodiments, the width [symbol] ₁ is greater than 0.01 and less than 1 micron. For example, in various embodiments, the width [symbol] ₁ is at least 0.1 microns and no more than 0.5 microns.

The periodically perturbed waveguide 122 extends a length [symbol] ₂ in the resonator direction. In various embodiments, the length [symbol] ₂ is less than 100 microns. For example, in various embodiments, the length [symbol] ₂ is greater than 1 micron and less than 90 microns. For example, in various embodiments, the length [symbol] ₂ is at least 10 microns and no more than 50 microns.

FIG. 2 illustrates another example embodiment of a resonant photonic element 200. The resonant photonic element 200 includes a propagation waveguide 210. The propagation waveguide 210 is configured to propagate and/or guide light along the propagation waveguide 210. The propagation waveguide 210 defines propagation direction 212. The propagation direction 212 is the direction along which the propagation waveguide 210 is configured to propagate and/or guide light along the propagation waveguide 210.

The resonant photonic element 200 further includes a guided mode resonator 220. The guided mode resonator 220 includes two periodically perturbed waveguides 222A, 222B. Each of the periodically perturbed waveguides 222A, 22B is a respective waveguide that includes periodic perturbations 225. In the illustrated embodiment, the periodic perturbations 225 are periodic notches in the respective first surfaces and second surfaces of the periodically perturbed waveguides 222A, 222B.

The periodically perturbed waveguides 222A, 222B are transverse to one another. For example, the periodically perturbed waveguides 222A, 222B intersect one another at the intersection 230. The periodically perturbed waveguides 222A, 222B intersect one another so as to form an angle α between the periodically perturbed waveguides 222A, 222B. In various embodiment, the angle α is greater than 0 and less than 180 degrees. In various embodiments, the angle α is at least 30 and no more than 150 degrees. In various embodiments, the angle α is at least 60 and no more than 120 degrees. In the illustrated embodiment, the angle α is approximately 90 degrees.

In various embodiments, the periodically perturbed waveguides 222A, 222B are both transverse to the propagation waveguide 210. For example, the periodically perturbed waveguides 222A, 222B interest each other and the propagation waveguide 210 at the intersection 230.

In various embodiments, the resonant photonic element 200 is used to control and/or affect the propagation of light along the propagation waveguide 210. For example, light propagates along the propagation waveguide 210 in the propagation direction 212. When the light reaches the intersection 230 where the propagation waveguide 210 and the periodically perturbed waveguides 222A, 222B intersect, the light interacts with the periodically perturbed waveguides 222A, 222B. Light that is resonant with the guided mode resonator 220 interacts and resonates with the guided mode resonator and passes through the intersection 230 and continues to propagate along the propagation waveguide 210. In various embodiments, light is resonant with the guided mode resonator 220 when the light is characterized by a wavelength (or frequency) and/or polarization that is resonant with the guided mode resonator 220. Light that is not resonant with the guided mode resonator 220 continues to propagate along the propagation waveguide 210 without being substantially affected by the guided mode resonator 220. In other words, light that is not resonant with the guided mode resonator 220 is propagated along the propagation waveguide 210 past and/or through the intersection 230. In various embodiments, light is not resonant with the guided mode resonator 220 when the light is characterized by a wavelength (or frequency) and/or polarization that is not resonant with the guided mode resonator 220. In various embodiments, the transmittance and/or reflectance of the intersection 230 is a continuous function (e.g., not a step function) of wavelength (or frequency) and/or polarization of the incident light with a well-defined peak at the resonant wavelength (or frequency) and/or polarization.

For example, by combining the two periodically perturbed waveguides 22A, 22B such that they intersect the propagation waveguide 210 at the same location, two co-located resonances are provided. In various embodiments, the relative phase shifts of the two co-located resonances are engineered and/or designed to destructively interfere the resonant reflected light resulting in resonant light be forward propagated instead of reflected.

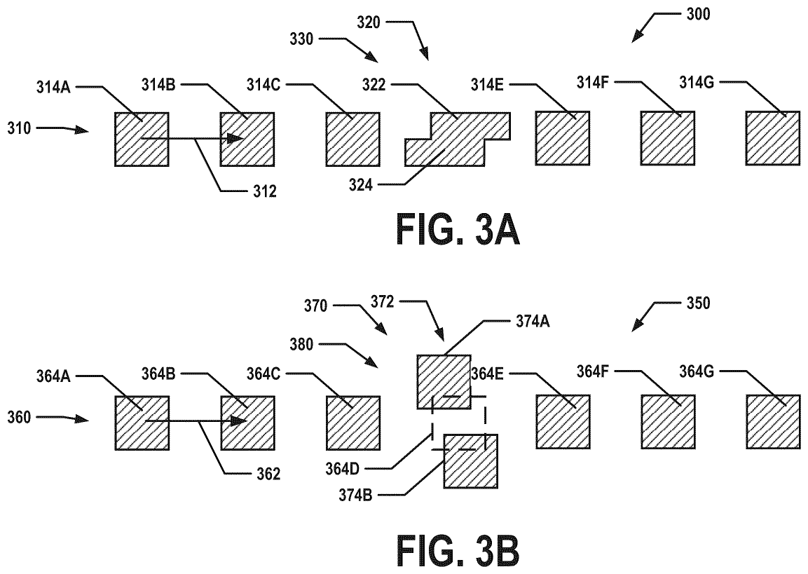

FIGS. 3A and 3B illustrates example embodiments of resonant photonic elements 300, 350 where the propagation waveguides 310, 360 are segmented waveguides (sub-wavelength grating waveguides, Huygens waveguides, and/or the like). For example, the propagation waveguide 310 is a segmented waveguide including a plurality or series of forward scattering waveguide segments 314 (e.g., 314A, 314B, 314C, 314E, 314F, 314G). The propagation waveguide 360 is another segmented waveguide including a plurality or series of forward scattering waveguide segments 364 (e.g., 364A, 364B, 364C, 364E, 364F, 364G). The forward scattering waveguide segments 314, 364 are dielectric metasurfaces, in an example embodiment, that are configured to scatter light incident thereon forward along the propagation direction 312, 362 of the propagation waveguide 310, 360.

The resonant photonic elements 300, 350 include nanophotonic resonators 320, 370 disposed at respective interaction points 330, 380. The nanophotonic resonators 320, 370 are resonators where the resonance is contained within a single localized resonator (compared to guided mode resonances which are a lattice effect). The nanophotonic resonances may be implemented using bound states in continuum (BIC) resonances, Fano resonances, or other high-Q resonant mechanisms. The nanophotonic resonator 320 includes a perturbed waveguide 322 consisting of a perturbed forward scattering waveguide segment 324. For example, the perturbed waveguide 322 includes asymmetrical extrusions from the resonator bulk. The nanophotonic resonator 370 includes a perturbed waveguide 372 consisting of two perturbed forward scattering waveguide segments 374 (e.g., 374A, 374B). The two perturbed forward scattering waveguide segments 374 are substantially identical resonators that have asymmetrical spacing relative to the series of forward scattering waveguide segments 364.

The perturbed forward scattering waveguide segments 324, 374 have respective topologies (e.g., having asymmetries relative to the respective series of forward scattering waveguide segments 314, 364) and/or geometries (e.g., having asymmetries embodied by the perturbed forward scatting waveguide segment itself) that break the symmetry and/or pattern of the forward scattering waveguide segments 314, 364 of the respective propagation waveguide 310, 360.

For example, the geometry and/or shape of the perturbed scattering waveguide segments 324 differs from that of the forward scattering waveguide segments 314. In another example, the geometry and/or topology of the arrangement of perturbed scattering waveguide segments 374 differs from that of the forward scattering waveguide segments 364. For example, the periodicity of the plurality and/or series of forward scattering waveguide segments 364 defines a location where forward scattering waveguide segment 364D would be if it were present. However, the forward scattering waveguide segment 364D is replaced with the two perturbed waveguide segments 374 which are offset from the location where the forward scattering waveguide segment 364D would be if it were present. The perturbed waveguide segments 374 may have a similar geometry and/or shape as the forward scattering waveguide segments 364, but are offset from the position where the forward scattering waveguide segment 464D would be if it were present.

The perturbed forward scattering waveguide segments 324, 374 are configured to act as a resonator such that as light propagates along a respective propagation waveguide 310, 360 in the propagation direction 312, 362 until the light reaches the interaction point 330, 380. At the interaction point 330, 380, the light interacts with the perturbed forward scatting waveguide segment(s) 324, 274. Light that is characterized by a wavelength and/or polarization that is not resonant with the nanophotonic resonator 320, 370 will not resonate within and/or interact with the resonator and will continue to propagate and/or be guided along the propagation waveguide 310, 360. Light that is characterized by a wavelength and/or polarization that is resonant with the nanophotonic resonator 320, 370 will resonate within the resonator and will be reflected (e.g., possibly out of the plane of the page) and/or dampened such that the resonant light does not continue to propagate and/or be guided along the propagation waveguide 310, 360.

In various embodiments, the transmittance and/or reflectance of the interaction point 330, 380 is a continuous function (e.g., not a step function) of wavelength (or frequency) and/or polarization of the incident light with a well-defined peak at the resonant wavelength (or frequency) and/or polarization.

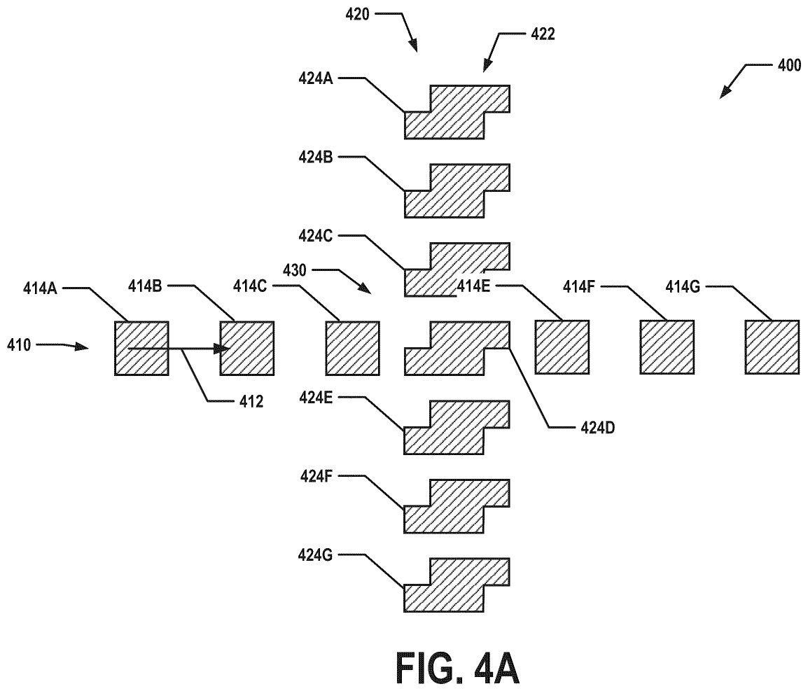

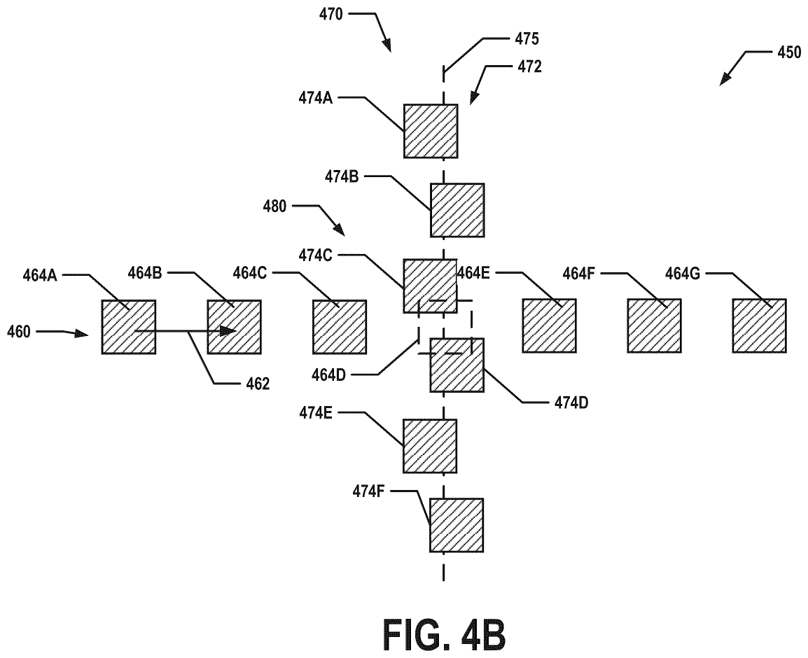

In various embodiments, a second resonance is co-located with the first resonance provided by the perturbed forward scattering waveguide segment(s) 324, 374. The second resonance has a similar spectral response to the first resonance and a relative phase shift that results in destructive interference of light scattered away from the waveguide (e.g., possibly out of the plane of the page). FIGS. 4A and 4B show example embodiments where the second resonance is provided by arrays of resonators.

FIGS. 4A and 4B illustrate two more examples of resonant photonic elements 400, 450 including segmented waveguides (e.g., sub-wavelength grating waveguides, Huygens waveguides, and/or other segmented waveguide). The resonant photonic elements 400, 450 include the propagation waveguides 410, 460 that are segmented waveguides. For example, the propagation waveguide 410 is a Huygens waveguide including a plurality or series of forward scattering waveguide segments 414 (e.g., 414A, 414B, 414C, 414E, 414F, 414G). The propagation waveguide 460 is another segmented waveguide including a plurality or series of forward scattering waveguide segments 464 (e.g., 464A, 464B, 464C, 464E, 464F, 464G). The forward scattering waveguide segments 414, 464 are dielectric metasurfaces, in an example embodiment, that are configured to scatter light incident thereon forward along the propagation direction 412, 462 of the propagation waveguide 410, 460.

The resonant photonic elements 400, 450 include nanophotonic resonators 420, 470 that intersect the propagation waveguides 410, 460 at respective interaction points 430, 480. The nanophotonic resonator 420 includes a periodically perturbed waveguide 422 consisting of a series of perturbed scattering waveguide segments 424 (e.g., 424A, 424B, 424C, 424D, 424E, 424F, 424G). The periodically perturbed waveguide 422 extends in a resonator direction that is transverse and/or perpendicular to the propagation direction 412. The nanophotonic resonator 470 includes a periodically perturbed waveguide 472 including a plurality or series perturbed scattering waveguide segments 474 (e.g., 474A, 474B, 474C, 474D, 474E, 474F). The perturbed scattering waveguide segments 424, 474 have respective topologies and/or geometries that break the symmetry and/or pattern of the forward scattering waveguide segments 414, 464 of the respective propagation waveguide 410, 460.

For example, the geometry and/or shape of the perturbed scattering waveguide segments 424 differs from that of the forward scattering waveguide segments 414. In another example, the geometry and/or topology of the arrangement of perturbed scattering waveguide segments 474 differs from that of the forward scattering waveguide segments 464. For example, the geometry and/or topology of the arrangement of the forward scattering waveguide segments 464 defines an axis 475 at the interaction point 480. The periodicity of the plurality and/or series of forward scattering waveguide segments 464 defines a location where forward scattering waveguide segment 464D would be if it were present. However, the forward scattering waveguide segment 464D is replaced with the perturbed waveguide segments 474. The perturbed waveguide segments 474 have a similar geometry and/or shape as the forward scattering waveguide segments 464, but are offset from the axis 475 along which the forward scattering waveguide segment 464D would be centered.

The periodically perturbed waveguides 422, 472 are configured to act as resonators such that as light propagates along a respective propagation waveguide 410, 460 in the propagation direction 412, 462 until the light reaches the interaction point 430, 480. At the interaction point 430, 480, the light interacts with the perturbed forward scatting waveguide segment(s) 424, 474 of the periodically perturbed waveguides 422, 472. Light that is characterized by a wavelength and/or polarization that is not resonant with the nanophotonic resonator 420, 470 will note resonate within and/or interact with the resonator and will continue to propagate and/or be guided along the propagation waveguide 410, 460. Light that is characterized by a wavelength and/or polarization that is resonant with the nanophotonic resonator 420, 470 will resonate within the resonator and will be reflected and/or dampened such that the (forward propagating) resonant light does not continue to propagate and/or be guided along the propagation waveguide 410, 460.

In various embodiments, the propagation waveguides 110, 210, 310, 360, 410, 460 are conventional continuous waveguides and/or conventional segmented waveguides. For example, propagation waveguides 110, 210 are formed of dielectric material, glass, Silica, and/or other material configured to propagate and/or guide light characterized by a wavelength of interest (or a range of wavelengths including the wavelength of interest), in various embodiments. In various embodiments, the propagation waveguides 110, 210 are strip waveguides, rib waveguides, slab waveguides, and/or other continuous waveguides. In various embodiments, the propagation waveguides 310, 360, 410, 460 are formed of dielectric metasurfaces, and/or the like. For example, the propagation waveguides 310, 360, 410, 460 are sub-wavelength grating waveguides, Huygens waveguides, or other segmented waveguides, in various embodiments.

In various embodiments, the (periodically) perturbed waveguides 122, 222, 322, 372, 422, 472 are continuous waveguides and/or segmented waveguides. For example, (periodically) perturbed waveguides 122, 222 are formed of dielectric material, glass, Silica, and/or other material configured to propagate and/or guide light characterized by a wavelength of interest (or a range of wavelengths including the wavelength of interest), in various embodiments. In various embodiments, the (periodically) perturbed waveguides 122, 222 are perturbed strip waveguides, rib waveguides, slab waveguides, and/or other continuous waveguides. In various embodiments, the (periodically) perturbed waveguides 322, 372, 422, 472 are formed of dielectric metasurfaces, and/or the like. For example, the (periodically) perturbed waveguides 322, 372, 422, 472 are sub-wavelength grating waveguides, Huygens waveguides, one or more photonic crystals, or other segmented waveguides, in various embodiments. In various embodiments, the (periodically) perturbed waveguides 122, 222, 322, 372, 422, 472 are formed of active and/or non-linear material (e.g., a lithium niobate, a material including Ga, a semiconductor III-V (e.g., GaN, GaP, and/or the like), and/or other material that provides a non-linear and/or gain optical effect).

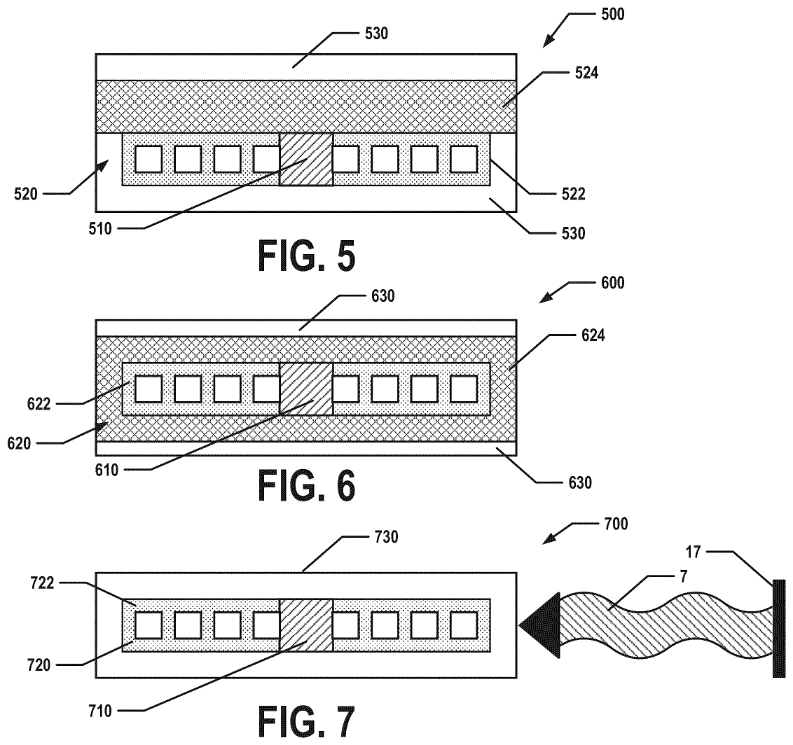

In various embodiments, the guided mode resonator of the resonant photonic element includes additional elements and/or features in addition to a (periodically) perturbed waveguide. FIGS. 5, 6, and 7 illustrate various embodiments of resonant photonic elements where the resonant photonic element is embedded in material that is part of the guided mode resonator of the resonant photonic element.

FIG. 5 provides a cross-sectional view of a resonant photonic element 500 comprising a propagation waveguide 510 defining a propagation direction that is out of the plane of the page. The resonant photonic element 500 further includes a guided mode resonator 520 including a periodically perturbed waveguide 522 and a modification material 524. In various embodiments, the modification material 524 is proximate the periodically perturbed waveguide 522. For example, in the illustrated embodiment, the modification material 524 is in physical contact with the periodically perturbed waveguide 522. In an example embodiment, the modification material 524 is not in physical contact with the periodically perturbed waveguide 522, but is located near enough to the periodically perturbed waveguide 522 that the change in the index of refraction of the modification material 524 affects and/or changes the wavelength (or frequency) and/or polarization that is resonant with the guided mode resonator 520.

In various embodiments, the modification material 524 is an active material. For example, the index of refraction of the modification material 524 may be modified through application of electric fields, voltage, current, magnetic fields, and/or the like to the modification material 524. When the refractive index of the modification material 524 is modified and/or changed, the wavelength (or frequency) and/or polarization that is resonant with the guided mode resonator 520 is modified.

In an example embodiment, a changeable spacer material (e.g., a piezoelectric spacer material) may be used to change how close the modification material 524 is located to the guided mode resonator 520. When the distance between the modification material 524 is modified and/or changed, the wavelength (or frequency) and/or polarization that is resonant with the guided mode resonator 520 is modified.

The resonant photonic element 500 is embedded in cladding 530. For example, the cladding 530 is configured to optically isolate the resonant photonic element 500 from the surrounding environment.

FIG. 6 illustrates an example resonant photonic element 600 comprising a propagation waveguide 610 defining a propagation direction that is out of the plane of the page. The resonant photonic element 600 further includes a guided mode resonator 620 including a periodically perturbed waveguide 622 and a modification material 624. In various embodiments, the periodically perturbed waveguide 622 is embedded in the modification material 624.

In various embodiments, the modification material 624 is an active material. For example, the index of refraction of the modification material 624 may be modified through application of electric fields, voltage, current, magnetic fields, and/or the like to the modification material 624. When the refractive index of the modification material 624 is modified and/or changed, the wavelength (or frequency) and/or polarization that is resonant with the guided mode resonator 620 is modified.

The resonant photonic element 600 is additionally includes cladding 630. For example, the cladding 630 is configured to optically isolate the resonant photonic element 600 from the surrounding environment.

FIG. 7 provides a cross-section of an example resonant photonic element 700 comprising a propagation waveguide 710 defining a propagation direction that is out of the plane of the page. The resonant photonic element 700 further includes a guided mode resonator 720 including a periodically perturbed waveguide 722. The resonant photonic element 700 additionally includes cladding 730. For example, the cladding 730 is configured to optically isolate the resonant photonic element 700 from the surrounding environment.

An acoustic wave and/or sound source 17 is configured to generate an acoustic and/or sound wave 7 that is directed toward the resonant photonic element 700. The acoustic and/or sound wave 7 interacts with the resonant photonic element 700 and causes the resonant wavelength (or frequency) and/or polarization of the guided mode resonator 720 to be modified.

In various embodiments, the periodically perturbed waveguide is symmetric with respect to an axis that passes through the intersection of the propagation waveguide and the periodically perturbed waveguide and that is perpendicular to the direction of propagation. For example, the first surface 124 and the second surface 126, which are opposite one another with respect to the propagation direction 112, are similarly perturbed (e.g., notched). This symmetry enables light to propagate and/or be guided through the propagation waveguide 110 in the propagation direction 112 and in a direction opposite the propagation direction 112 with the same resonance effects. For example, light propagating through the propagation waveguide 110 in the direction opposite the propagation direction, light that is resonant with the guided mode resonator 120 interacts and resonates with the guided mode resonator and passes through the intersection 130 and continues to propagate along the propagation waveguide 110 and light that is not resonant with the guided mode resonator 120 interacts with the guided mode resonator 120 such that the non-resonant light is damped and/or reflected.

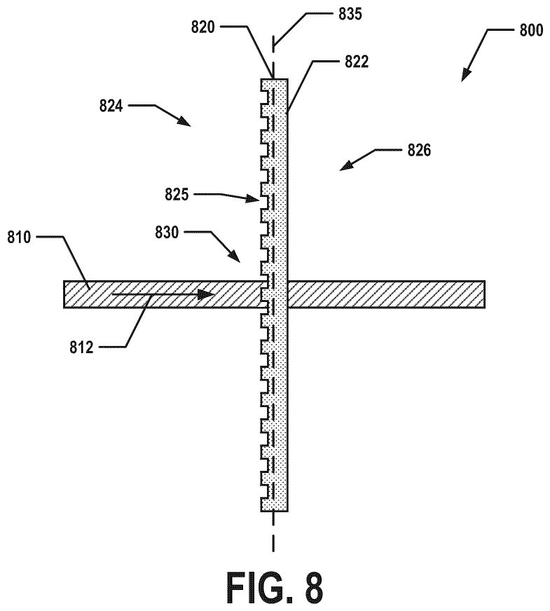

FIG. 8 illustrates an example resonant photonic element 800 that is not symmetric with respect to an axis 835 that extends through the intersection 830 of the propagation waveguide 810 and the periodically perturbed waveguide 822 of the guided mode resonator 820 and that is perpendicular to the propagation direction 812. For example, the first surface 824 of the periodically perturbed waveguide 822 includes periodic perturbations 825 (e.g., notches) and the second surface 826 of the periodically perturbed waveguide 822 does not include a perturbation. For example, the second surface 826 of the periodically perturbed waveguide 822 is a generally smooth waveguide surface. Light propagating through the propagation waveguide 810 in the propagation direction 812 and that is resonant with the guided mode resonator 820 interacts and resonates with the guided mode resonator and passes through the intersection 830 and continues to propagate along the propagation waveguide 810 in the propagation direction 812 and light that is not resonant with the guided mode resonator 820 interacts with the guided mode resonator 820 such that the non-resonant light is damped and/or reflected. However, light propagating through the propagation waveguide 810 in the direction opposite the propagation direction is dampened and/or reflected, even when the light is resonant with the guided mode resonator 820. For example, the resonant photonic element 800 acts as an optical isolator and/or a one-way optical valve, filter, modulator, and/or the like.

### Example Optical Components Including Resonant Photonic Elements

In various embodiments, resonant photonic elements 100, 200, 300, 400, 500, 600, 700, 800 are incorporated into optical components. For example, in an example embodiment, a resonant photonic element 100, 200, 300, 400, 500, 600, 700, 800 may be incorporated into an optical filter. For example, the optical filter is configured to pass light that is resonant with the guided mode resonator of the resonant photonic element with a linewidth defined based at least in part by the perturbation of the (periodically) perturbed waveguide. For example, the depth of the periodic perturbations 125, 825 (e.g., notches), may be used to control and/or define the linewidth that the optical filter will pass.

In another example embodiment, a resonant photonic element is used as an active element of an amplitude modulator and/or switch. For example, the resonance of the guided mode resonator 120 of an resonant photonic element 100 may be actively controlled directly (e.g., the periodically perturbed waveguide 122 may be made of a material that enables the index of refraction of the periodically perturbed waveguide 122 to be actively and/or dynamically modified so as to change the resonance thereof) or indirectly (e.g., via a modification material 524, 624, application of an acoustic and/or sound wave 7, and/or the like). An optical signal (e.g., laser beam) may be continuously provided to the propagation waveguide 110. The resonance of the guided mode resonator 120 may be tuned such that the wavelength (or frequency) and/or polarization of the optical signal is resonant with the guided mode resonator 120 to enable the light to pass through the intersection 130 and continue to propagate along the propagation waveguide 110. The resonance of the guided mode resonator 120 may be tuned such that the wavelength (or frequency) and/or polarization of the optical signal is not resonant with the guided mode resonator 120 to stop and/or prevent the light from passing through the intersection 130 and such that the light does continue to propagate along the propagation waveguide 110.

In various embodiments, a resonant photonic element 200 may be incorporated into a phase modulator and/or Mach-Zehnder interferometer (MZI). For example, the resonant photonic element 200 may be used to modify the phase of light passing therethrough. In an example embodiment, the resonant photonic element 200 is configured to modify the phase of light passing therethrough as an arm of an MZI. In another example, the resonant photonic element 200 may be used as an active element of a phase balancing optical component.

In an example embodiment, the optical component is a laser or an optical amplifier. For example, in an example embodiment, the (periodically) perturbed waveguide includes an active material (e.g., Ga, a III-V semiconductor, and/or the like). When light propagating along the propagation waveguide is resonant with the guided mode resonator, the resonant photonic element amplifies the light via the active material in the (periodically) perturbed waveguide.

In various embodiments, the optical component is a down converter or an up converter. For example, in an example embodiment, the (periodically) perturbed waveguide includes a non-linear material that is configured to either up convert the frequency or down convert the frequency of light that is resonant with the guided mode resonator of the resonant photonic element. For example, in an example embodiment, the optical component is a down converter that when light that is resonant with the guided mode resonator interacts with the guided mode resonator, the light that continues propagating along the propagation waveguide has a frequency that is half that of the incident light. In another example embodiment, the optical component is an up converter that when light that is resonant with the guided mode resonator interacts with the guided mode resonator, the light that continues propagating along the propagation waveguide has a frequency that is twice or two times that of the incident light.

Various other optical components may include various embodiments of resonant photonic elements, in various embodiments.

### Example System Including Resonant Photonic Elements

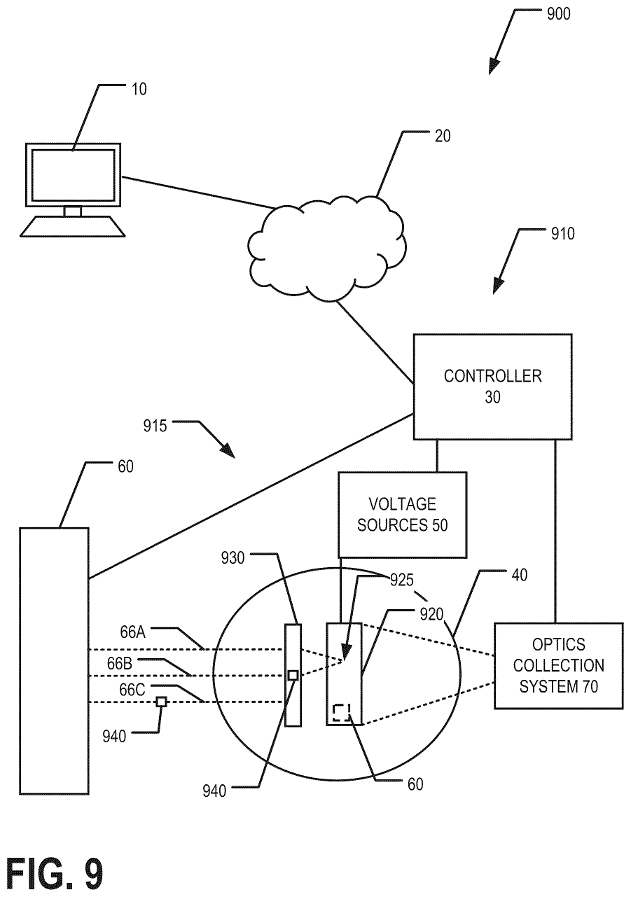

In various embodiments, a resonant photonic element is incorporated into an optical component. The optical component may be incorporated into a system. One example system into which an optical component including a resonant photonic element may be incorporated is an atomic system or a quantum system such as a quantum charge-coupled device (QCCD)-based quantum computer. FIG. 9 provides a schematic diagram of an example QCCD-based quantum computing system 900, in accordance with an example embodiment. The QCCD-based quantum computing system 900 includes optical components 940 that include respective resonant photonic elements.

In various embodiments, the quantum computing system 900 comprises a computing entity 10 and a quantum computer 910. In various embodiments, the quantum computer 910 comprises a controller 30, a cryostat and/or vacuum chamber 40 enclosing a confinement apparatus 920 (e.g., an ion trap), and one or more manipulation sources 60. For example, the cryostat and/or vacuum chamber 40 may be a pressure-controlled chamber. In an example embodiment, the manipulation signals generated by the manipulation sources 60 are provided to the interior of the cryostat and/or vacuum chamber 40 (where the confinement apparatus 920 is located) via corresponding optical paths 66 (e.g., 66A, 66B, 66C). In various embodiments, the optical paths 66 are defined, at least in part by one or more components and/or elements of the signal management system. For example, at least one of the optical paths 66 comprises and/or is in part defined by a signal manipulation element of the signal management system.

In various embodiments the optical paths 64 are configured to provide respective optical beams to one or more target locations 925 defined at least in part by the confinement apparatus 920. In an example embodiment, the optical component 940 is disposed outside of the cryogenic and/or vacuum chamber 40. In an example embodiment, the optical component 940 is disposed within the cryogenic and/or vacuum chamber 40. For example, a photonic integrated circuit 930 may be disposed within the cryogenic and/or vacuum chamber 40 and at least a portion of the optical component and/or resonant photonic element may be formed as part of the photonic integrated circuit 930. In an example embodiment, the optical component 940 may be formed at least in part on or in the substrate on which the confinement apparatus 920 is formed.

In an example embodiment, at least one manipulation source 60 is disposed within the cryostat and/or vacuum chamber 40. For example, in an example embodiment, one or more manipulation sources 60 are formed and/or disposed at least in part on and/or in the first substrate on which the confinement apparatus 920 is formed and/or disposed and/or on a second substrate (e.g., the photonic integrated circuit 930) that is mounted in a secured and/or controllable manner with respect to the confinement apparatus 920 within the cryostat and/or vacuum chamber 40.

In an example embodiment, the one or more manipulation sources 60 may comprise one or more coherent optical sources and/or one or more incoherent optical sources. For example, in an example embodiment, the one or more manipulation sources 60 comprise one or more lasers (e.g., optical lasers, microwave sources, VECSELs, VCSELs, and/or the like). In various embodiments, each manipulation source 60 is configured to generate a manipulation signal having a respective characteristic wavelength in the microwave, infrared, visible, or ultraviolet portion of the electromagnetic spectrum. In various embodiments, the one or more manipulation sources 60 are configured to manipulate and/or cause a controlled quantum state evolution of one or more particles confined and/or trapped by the confinement apparatus 920. For example, in an example embodiment, wherein the one or more manipulation sources 60 comprise one or more lasers, the lasers may provide one or more laser beams (e.g., as manipulation signals) to particles confined and/or trapped by the confinement apparatus 920 within the cryostat and/or vacuum chamber 40.

For example, a manipulation source 60 generates a manipulation signal that is provided as an incoming signal to an appropriate signal manipulation element of the signal management system. The incoming signal being incident on the signal manipulation element, for example an active metamaterial array (e.g., having one or more dynamically controllable optical effects), induces the plurality of metamaterial structures of the metamaterial array to emit an induced signal directed toward and/or focused at a corresponding particle position of the confinement assembly. For example, the manipulation sources 60 may be configured to generate one or more manipulations signals and/or beams that may be used to initialize a particle into a state of a qubit space such that the particle may be used as a qubit of the quantum computer 910, perform one or more gates on one or more qubits of the quantum computer 910, read and/or determine a state of one or more qubits of the quantum computer 910, and/or the like.

In various embodiments, the manipulation signals are configured to cause performance of various functions of the quantum computer 910 and/or other trapped particle system on one or more particles. An example function that may be performed on particle is photoionization of the quantum object. For example, a manipulation signal may be applied to the particle (e.g., via one or more signal manipulation elements) to photo-ionize the particle.

Another example function that may be performed on particle is state preparation of the particle. For example, one or more manipulation signals may be applied to the particle (e.g., via one or more signal manipulation elements) to prepare the particle in a particular quantum state. For example, the particular quantum state may be a state within a defined qubit space used by the quantum computer such that the particle may be used as a qubit of the quantum computer.

Another example function that may be performed on a particle is reading a quantum state of the particle. For example, a manipulation signal (e.g., a reading signal) may be applied to the particle (e.g., via one or more signal manipulation elements). When the particle's wave function collapses into a first state of the qubit space, the particle will fluoresce in response to the reading signal being applied thereto. When the particle's wave function collapses into a second state of the qubit space, the particle will not fluoresce in response to the reading signal being applied thereto.

Another example function that may be performed on a particle is cooling the particle or a particle crystal comprising the particle. A particle crystal is a pair or set of particles where one of the particles of the particle crystal is qubit particle used as a qubit of the quantum computer and the one or more other particles of the particle crystal are used to perform sympathetic cooling of the qubit particle. For example, a manipulation signal (e.g., a cooling signal or a sympathetic cooling signal) may be applied to the particle or particle crystal (e.g., via one or more signal manipulation elements) to cause the (qubit) particle to be cooled (e.g., reduce the vibrational and/or other kinetic energy of the (qubit) particle).

Another example function that may be performed on a particle is shelving the particle. In various embodiments, particles in the second state of the qubit space may be shelved during the performance of a reading function. For example, a shelving operation may comprise causing the quantum state of a particle in the second state of the qubit space to evolve to an at least meta-stable state outside of the qubit space while a reading operation is performed. An example shelving process is describe by U.S. Application No. 63/200,263, filed Feb. 25, 2021, though various other shelving processes may be used in various embodiments. In various embodiments, the shelving of particle is performed by applying one or more manipulation signals (e.g., via one or more signal manipulation elements) to the particle to cause the particle's quantum state to evolve to an at least meta-stable state outside of the qubit space when the particle is in the second state of the qubit space.

Another example function that may be performed on a particle is (optical) repumping of the particle. In various embodiments, repumping of the particle comprises applying one or more manipulation signals (e.g., via one or more signal manipulation elements) to the particle to cause the quantum state of the particle to evolve to an excited state.

Another example function that may be performed on a particle is performing a single qubit gate on the particle. For example, one or more manipulation signals may be applied to the particle (e.g., via one or more signal manipulation elements) to perform a single qubit quantum gate on the particle.

Another example function that may be performed on a particle is performing a two-qubit gate on the particle. For example, one or more manipulation signals may be applied to a pair or set of particles that includes the particle (e.g., via one or more signal manipulation elements) to perform a two qubit (or three, four, or more qubit) quantum gate on the particle and the at least one other particle.

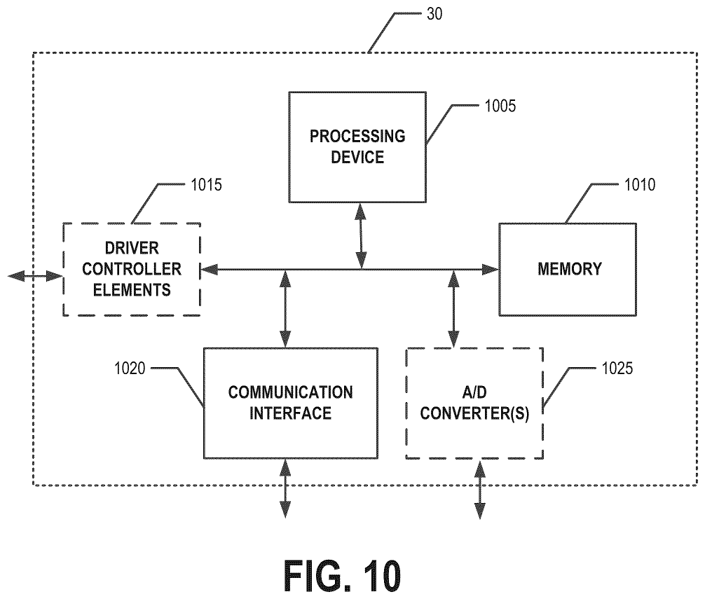

In various embodiments, the quantum computer 910 comprises an optics collection system 70 configured to collect and/or detect photons generated by qubits (e.g., during reading procedures). The optics collection system 70 may comprise one or more optical elements (e.g., lenses, mirrors, waveguides, fiber optics cables, and/or the like) and one or more photodetectors. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum computer. In various embodiments, the detectors may be in electronic communication with the controller 30 via one or more A/D converters 1025 (see FIG. 10) and/or the like. For example, a particle being read and/or having its quantum state determined may emit a stimulated signal, at least a portion of which is incident on a signal manipulation element of the signal management system. The incident signal being incident on the signal manipulation element induces the signal manipulation element to emit an induced signal directed toward and/or focused at collection optics of the confinement assembly and located at the collection location corresponding to the particle position that the particle is occupying. The collection optics are configured to provide the collection signal to a photodetector.

In various embodiments, the quantum computer 910 comprises one or more voltage sources 50. For example, the voltage sources 50 may comprise a plurality of voltage drivers and/or voltage sources and/or at least one RF driver and/or voltage source. The voltage sources 50 may be electrically coupled to the corresponding potential generating elements (e.g., electrodes) of the confinement apparatus 920, in an example embodiment.

In various embodiments, a computing entity 10 is configured to allow a user to provide input to the quantum computer 910 (e.g., via a user interface of the computing entity 10) and receive, view, and/or the like output from the quantum computer 910. The computing entity 10 may be in communication with the controller 30 of the quantum computer 910 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control the voltage sources 50, cryostat system and/or vacuum system controlling the temperature and pressure within the cryostat and/or vacuum chamber 40, manipulation sources 60, optics collection system 70, states of various signal manipulation elements, and/or other systems controlling various environmental conditions (e.g., temperature, pressure, and/or the like) within the cryostat and/or vacuum chamber 40 and/or configured to manipulate and/or cause a controlled evolution of quantum states of one or more particles within the confinement assembly. For example, the controller 30 may cause a controlled evolution of quantum states of one or more particles within the confinement assembly to execute a quantum circuit and/or algorithm. For example, the controller 30 may cause a reading procedure comprising coherent shelving to be performed, possibly as part of executing a quantum circuit and/or algorithm. In various embodiments, the particles are confined within the confinement assembly are used as qubits of the quantum computer 910.

### Example Controller

In various embodiments, a confinement apparatus 920 is incorporated into a system (e.g., a quantum computer 910 or other trapped particle system) comprising a controller 30. In various embodiments, the controller 30 is configured to control various elements of the system (e.g., quantum computer 910 or other trapped particle system). For example, the controller 30 may be configured to control the state of the dynamically controllable optical properties of one or more optical components 940 comprising resonant photonic elements. For example, the controller 30 may be configured to control the voltage sources 50, a cryostat system and/or vacuum system controlling the temperature and pressure within the cryostat and/or vacuum chamber 40, manipulation sources 60, cooling system, and/or other systems controlling the environmental conditions (e.g., temperature, humidity, pressure, and/or the like) within the cryostat and/or vacuum chamber 40 and/or configured to manipulate and/or cause a controlled evolution of quantum states of one or more quantum objects confined by the confinement apparatus 920. In various embodiments, the controller 30 may be configured to receive signals from one or more optics collection systems 70.

As shown in FIG. 10, in various embodiments, the controller 30 may comprise various controller elements including processing device 1005, memory 1010, driver controller elements 1015, a communication interface 1020, analog-digital converter elements 1025, and/or the like. For example, the processing device 1005 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 1005 of the controller 30 comprises a clock and/or is in communication with a clock.

For example, the memory 1010 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1010 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 1010 (e.g., by a processing device 1005) causes the controller 30 to perform one or more steps, operations, processes, procedures and/or the like described herein for providing manipulation signals to quantum object positions and/or collecting, detecting, capturing, and/or measuring indications of emitted signals emitted by quantum objects located at corresponding quantum object positions of the confinement apparatus 920.

In various embodiments, the driver controller elements 1015 may include one or more drivers and/or controller elements each configured to control one or more drivers. In various embodiments, the driver controller elements 1015 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 1005). In various embodiments, the driver controller elements 1015 may enable the controller 30 to operate a voltage sources 50, manipulation sources 60, cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping potential of the confinement apparatus 920 (and/or other drivers for providing driver action sequences to potential generating elements of the quantum object confinement assembly); cryostat and/or vacuum system component drivers; cooling system drivers, and/or the like. In various embodiments, the controller 30 comprises means for communicating and/or receiving signals from one or more optical receiver components (e.g., photodetectors of the optics collection system). For example, the controller 30 may comprise one or more analog-digital converter elements 1025 configured to receive signals from one or more optical receiver components (e.g., a photodetector of the optics collection system), calibration sensors, and/or the like.

In various embodiments, the controller 30 may comprise a communication interface 1020 for interfacing and/or communicating with a computing entity 10. For example, the controller 30 may comprise a communication interface 1020 for receiving executable instructions, command sets, and/or the like from the computing entity 10 and providing output received from the quantum computer 910 (e.g., from an optics collection system 70) and/or the result of a processing the output to the computing entity 10. In various embodiments, the computing entity 10 and the controller 30 may communicate via a direct wired and/or wireless connection and/or via one or more wired and/or wireless networks 20.

### Example Computing Entity

FIG. 15 provides an illustrative schematic representative of an example computing entity 10 that can be used in conjunction with embodiments of the present invention. In various embodiments, a computing entity 10 is configured to allow a user to provide input to the quantum computer 910 (e.g., via a user interface of the computing entity 10) and receive, display, analyze, and/or the like output from the quantum computer 910.

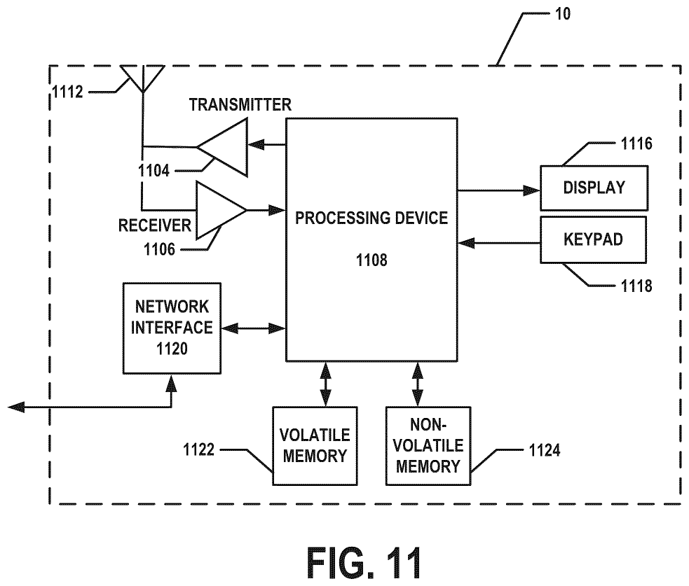

As shown in FIG. 11, a computing entity 10 can include an antenna 1112, a transmitter 1104 (e.g., radio), a receiver 1106 (e.g., radio), and a processing device 1108 that provides signals to and receives signals from the transmitter 1104 and receiver 1106, respectively. The signals provided to and received from the transmitter 1104 and the receiver 1106, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

For example, the processing device 1108 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products.

In various embodiments, the computing entity 10 may comprise a network interface 1120 for interfacing and/or communicating with the controller 30, for example. For example, the computing entity 10 may comprise a network interface 1120 for providing executable instructions, command sets, and/or the like for receipt by the controller 30 and/or receiving output and/or the result of a processing the output provided by the quantum computer 910. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 1116 and/or speaker/speaker driver coupled to a processing device 1108 and a touch screen, keyboard, mouse, and/or microphone coupled to a processing device 1108). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1118 (hard or soft), a touch display, voice/speech or motion interfaces, scanners, readers, or other input device. In embodiments including a keypad 1118, the keypad 1118 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1122 and/or non-volatile storage or memory 1124, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Technical Advantages

Conventionally, high quality resonators used to perform active photonic functions are formed by ring resonators having diameters on the order of several hundred microns to a millimeter. These ring resonators take up a significant amount of physical space and result in a significant amount of power dissipation. For optical channels that include several to many optical channels or for systems having stringent space and/or power requirements, the large conventional ring resonators cause significant technical challenges.

Various embodiments provide technical solutions to these technical problems. For example, various embodiments provide resonant photonic elements including high quality (high-Q) GMR Q-BIC resonators. These high-Q GMR Q-BIC resonators are significantly smaller than conventional high-Q ring resonators (e.g., having lengths of less than 100 microns compared to diameters of the ring resonators of several hundred microns to a millimeter) and dissipate significantly less power. Thus, various embodiments provide technical improvements to the fields of resonant photonic elements, optical components comprising resonant photonic elements, and systems comprising optical components.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A resonant photonic element comprising:
a propagation waveguide defining a propagation direction; and
a guided mode resonator comprising a periodically perturbed waveguide,
wherein the periodically perturbed waveguide is a waveguide that extends a first length in a resonator direction, the resonator direction is transverse to the propagation direction, and the periodically perturbed waveguide intersects the waveguide.

2. The resonant photonic element of claim 1, wherein the periodically perturbed waveguide has a first surface and a second surface, the first surface of the periodically perturbed waveguide being opposite the second surface of the periodically perturbed waveguide with respect to the propagation direction, and the periodically perturbed waveguide is a waveguide comprising at least one of:
notches in at least one of the first surface of the periodically perturbed waveguide or the second surface of the periodically perturbed waveguide,
holes along a center of the periodically perturbed waveguide,
bumps along at least one of the first surface or the second surface, or
a periodic structure in a refractive index or absorption of the periodically perturbed waveguide.

3. The resonant photonic element of claim 1, wherein the guided mode resonator is formed of material that has an index of refraction that can be actively modified/controlled.

4. The resonant photonic element of claim 1, further comprising a modification material disposed in proximity to the guided mode resonator, wherein the modification material is actively modifiable, and modification of the modification material causes a change in a resonance of the guided mode resonator.

5. The resonant photonic element of claim 1, wherein the guided mode resonator and at least a portion of the propagation waveguide are at least partially embedded in an active material.

6. The resonant photonic element of claim 1, wherein the guided mode resonator is formed of active material and the resonant photonic element is a laser or optical amplifier.

7. The resonant photonic element of claim 1, wherein the guided mode resonator is formed of a non-linear material and the resonant photonic element is configured to perform down-conversion or up-conversion.

8. The resonant photonic element of claim 1, wherein the resonant photonic element is an amplitude modulator or a switch.

9. The resonant photonic element of claim 1, wherein the resonant photonic element is a frequency filter.

10. The resonant photonic element of claim 1, wherein the periodically perturbed waveguide comprises a first periodically perturbed waveguide arm and a second periodically perturbed waveguide arm, the first periodically perturbed waveguide arm and the second periodically perturbed waveguide arm overlap where the first periodically perturbed waveguide arm and the second periodically perturbed waveguide arm intersect the propagation waveguide, and the first periodically perturbed waveguide arm and the second periodically perturbed waveguide arm are transverse to one another.

11. The resonant photonic element of claim 10, wherein the resonant photonic element is a phase modulator.

12. The resonant photonic element of claim 11, wherein the phase modulator is part of a Mach-Zehnder interferometer.

13. The resonant photonic element of claim 1, wherein the periodically perturbed waveguide is symmetric with respect to an axis that is transverse or perpendicular to the propagation direction.

14. The resonant photonic element of claim 1, wherein the periodically perturbed waveguide comprises a first surface and a second surface, the first surface being opposite the second surface with respect to the propagation direction, and a periodic perturbation of the periodically perturbed waveguide is present on only one of the first surface or the second surface.

15. The resonant photonic element of claim 14, wherein the resonant photonic element is an optical isolator.

16. The resonant photonic element of claim 1, wherein at least one of:
the propagation waveguide is a Huygens waveguide or a sub-wavelength grating waveguide, or
the periodically perturbed waveguide is a Huygens waveguide or a sub-wavelength grating waveguide.

17. The resonant photonic element of claim 16, wherein a perturbation of the periodically perturbed waveguide is a non-symmetry in the Huygens waveguide or the sub-wavelength grating waveguide with respect to the propagation direction.

18. A system comprising:
a confinement apparatus configured to confine manipulatable objects and defining, at least in part, at least one target location;
a manipulation source configured to generate and provide a manipulation signal; and
a beam path system, the beam path system configured to guide the manipulation signal generated by the manipulation source to the at least one target location, the beam path system comprising a resonant photonic element comprising:
a propagation waveguide defining a propagation direction; and
a guided mode resonator comprising a periodically perturbed waveguide, wherein the periodically perturbed waveguide is a waveguide that extends a first length in a resonator direction, the resonator direction is transverse to the propagation direction, and the periodically perturbed waveguide intersects the waveguide.

19. The system of claim 18, wherein the periodically perturbed waveguide has a first surface and a second surface, the first surface of the periodically perturbed waveguide being opposite the second surface of the periodically perturbed waveguide with respect to the propagation direction, and the periodically perturbed waveguide is a waveguide comprising at least one of:
notches in at least one of the first surface of the periodically perturbed waveguide or the second surface of the periodically perturbed waveguide,
holes along a center of the periodically perturbed waveguide,
bumps along at least one of the first surface or the second surface, or
a periodic structure in a refractive index or absorption of the periodically perturbed waveguide.

20. The system of claim 18, wherein the resonant photonic element is at least one of a modulator or a frequency filter.
